(19) United States
(12) Patent Application Publication
(10) Pub. No.: US 2007/0239848 A1
(43) Pub. Date: Oct. 11, 2007

(54) UNIFORM RESOURCE LOCATOR VECTORS

(76) Inventor: John Avery, Newnan, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/733,760

(22) Filed: Apr. 10, 2007

Related U.S. Application Data
(60) Provisional application No. 60/791,154, filed on Apr. 11, 2006.

(51) Int. Cl. G06F 15/16

(52) U.S. Cl. 709/217

(57) ABSTRACT

A URL Vector is a URL represented by a digital picture, sound, or video. For example, a URL Vector consisting of a digital picture is created by taking a picture of an object that includes a logo in the picture frame. The logo is processed and used to perform a normalization process on the picture. A URL is then associated with the picture. A subsequent party may take a picture of the same object and also include the logo in the picture frame, or take a picture of a picture that already includes the logo. The recent picture is then loaded up to a web search engine that first identifies the logo, processes the logo and performs a normalization process on the image. The image is then compared to a database of images to find the closest match. If a match is found, the user is directed to a web page or web content associated with the URL. Similar to a URL Vector consisting of a digital picture, a URL Vector consisting of a digital sound or video must also include a standard sound or object for the purpose of creating a baseline for use in the normalization process.

### CROSS-REFERENCE TO RELATED APPLICATIONS

This application is a United States application for patent filed under 35 CFR 1.53(b) and claims priority to and the benefit of the filing date of United States Provisional application for patent filed on Apr. 11, 2006 and assigned Ser. No. 60/791,154

### FIELD OF THE INVENTION

The present invention relates to Internet browsing technology and, more specifically, to utilizing a picture or graphic or sound or video as a uniform resource locator.

### BACKGROUND OF THE INVENTION

The use of the Internet has exploded since the 1990's. Even people that would never have anticipated using a computer, much less owning a computer and using it on a daily basis, can be found shopping the local computer store for the latest and greatest computer system and then surfing the web for information, friends, weather reports or the best deal on new or used equipment or products. This concept that years ago if mentioned at the local cocktail party would have left your friends blinking at you like toads in a hailstorm, is now a commonplace term. This is the concept of a uniform resource locator or URL. Phrases like “click on the link” or “what is the URL for that web-site” are heard almost as frequently as “what is your number”.

A definition for a URL as provided by the Library of Congress is that a URL is a string, structured according to the syntax of Internet Engineering Task Force RFC 1738, that specifies the location of a resource on the Internet such as a file, an image or a downloadable document. A URL includes the type of naming scheme employed (http, ftp, telnet, news, file, etc.), a separating colon, the location of the host, and a path to the resource. URLs may be either absolute (containing the entire address of the resource) or relative (containing only a part of the address). Partial addresses may be used as long as the processing agent is able to resolve the full locations based on their context. Relative URLs enable terseness in documentation and the dynamic generation of links; they also minimize referential problems that may occur when hierarchical naming systems or file locations are modified.

Prior to the deployment of URLs, Internet users had to actually type in the physical Internet Protocol, or IP address, of a resource which takes the form of a multi-delineated number in the following format: WWW.XXX.YYY.ZZZ where each of the period separated fields is a three digit number ranging from a value of 1 to 255. Clearly, by being able to type in the phrase “http://www.yahoo.com” or “http://www.pict-urls.com” is much easier than having to remember and enter the IP address. Especially since most browsers can supplement a URL entry allowing a user to simply enter yahoo.com and have the browser complete the rest of the address.

In a typical web page encoded with a markup language, such as HTML, various links are included. A link basically consists of displayed text or graphic images that are associated with a URL. Thus, when a user browsing a web page places the cursor over the text or graphic, and then presses the mouse button, the URL associated with the text or graphic is loaded into the browser and the source destination is loaded into the browser window.

How has the Internet transformed the world? It would take a novel to fully cover all the changes brought about by the widespread growth of the Internet. However, probably one of the most prevalent changes that we see on a daily basis is the inclusion of a URL in most advertisements, business cards, letterheads, bulletin boards, etc. Where the typical consumer would grope around for a pen and paper to jot down a telephone number, they are now jotting down URLs and web addresses.

Another technology explosion has been in the integration of handheld electronics. Most notably is the inclusion of digital cameras in just about everything. Digital cameras small enough to fit into a shirt pocket are quite prevalent, as well as cellular telephones and PDAs that include multi-mega-pixel digital cameras. Even the most novice camera buff can now take quality pictures anywhere he or she may find themselves and load them into their personal computer or wireless Internet browser device.

Whether it be a cell phone, a PDA, a digital camera, or any other handheld electronic device, the inclusion of digital picture taking hardware, high resolution color screens, ever increasing data storage capacity, and wireless internet browsing capabilities has facilitated the evolution of barcode type systems. There is nothing new to using these systems of encoded binary data as a means to connect the user of a wireless handheld device to the address of specific web content without the need to physically enter a URL. If the handheld device can capture the binary code by use of its embedded camera, scanner, infrared beam, or other data transfer hardware, then it is technologically feasible to translate the binary into a web address that will be subsequently loaded into a browser.

Because computers speak in binary, a language consisting of ones and zeroes, long before the advent of cellular telephones there was a need for a system of encoding the description of everyday items in a way that computers could process. The bar code system was one of the first systems used by manufacturing industries, distribution channels, and point of sale outlets to track tangible items. To this day, bar codes can be found on everything from a can of creamed corn to a set of Waterford stemware. Bar codes are nothing more than a description of an item stored as binary data, thereby enabling a computer, via a bar code scanner, to identify the object to which the bar code is affixed. To do this, bar codes consist of a series of parallel lines of varying thickness and spacing which are translatable by a scanning device as binary code. Subsequently, the binary code represented by the bar codes can be displayed on a computer interface as a given item's description.

The problem with using a basic bar code system as a means to encode URLs is the potentially long length of a typical URL relative to the limited amount of data that can be reasonably encoded in a bar code. Theoretically, one could string a bar code out for miles but it wouldn't be practical to capture it in its entirety with the single snap of a digital camera. For this reason, most modern day developers of systems designed to tag tangible objects with a binary code capable of being captured by today's handheld electronics opted for modified versions of a bar code known collectively as matrix code (or two-dimensional bar code). Due to being two dimensional, matrix codes are capable of encoding large amounts of data in a relatively small area.

There are more than a handful of technologies that employ two-dimensional matrix symbologies as a means for encoding large amounts of data. Some of the more prevalent matrix symbologies are Data Matrix, Maxicode, Dataglyph (a proprietary Xerox scheme), QR Code, and ShotCode. All of the aforementioned two-dimensional symbologies have common attributes. Namely, each consists of a two-dimensional pattern made up of black and white shapes. A scanner device and program can read each individual shape within the pattern (blocks, dots, slashes, etc.) as representative of binary code.

The practical application of two-dimensional tags was perhaps first exploited by Denso Wave in the mid-1990s. Denso created a matrix code that it calls QR Code and has provided it to the public as an open standard. To this day, it is probably the most popular tagging standard used in Japan. Like any matrix code, a QR Code tag can be affixed to an object in the tangible world thereby efficiently encoding a URL address containing more information on the tangible object to which the tag is attached. An end user, assuming he or she possesses a handheld device capable of scanning the QR Code, can then access the designated URL without ever having to remember or physically enter the data into a mobile browser.

While slightly different in its chosen pattern, Data Matrix is another two-dimensional code with an open standard (ISO/IEC 16022) like that of Denso's QR Code. One of the more prevalent users of the Data Matrix tagging system is an organization by the name of SemaCode. SemaCode uses Data Matrix tags to provide a link to web content related to historical geographic sites and objects. Much like users of QR Code in Japan, if a person has a handheld device capable of scanning the Semacode tag then his mobile web browser can be automatically directed to a URL containing information about the tangible object displaying the tag.

A company called ShotCode developed a variation of Data Matrix and QR Code. Unlike Data Matrix and QR Code, a shotcode is a circular two-dimensional tag as opposed to square. Beyond the immediate difference of tag shape, a shotcode is basically the same as Data Matrix and QR Code because it uses using a pattern of black and white shapes to encode binary information. The binary information encoded in the shotcode, just like the information encoded by a Data Matrix or QR Code tag, is used to automatically link a mobile technology user's web browser to a predetermined URL.

Further, beyond the similarities in the tags themselves, the actual systems used to access the information encoded by two-dimensional matrix symbologies are much the same. Whether Data Matrix, QR Code, or ShotCode, users wishing to access the encoded information must have mobile handheld devices equipped with specific software used to scan and read the given symbology being employed. To this extent, having a handheld device with an embedded digital camera and web browsing capability is not enough to access the information encoded in the tag. The user must also have downloaded on his or her device the scanner software necessary to locate the specific type of two-dimensional tag within the digital picture and then decode it. Once the scanner software has decoded the binary data from the tag, it sends the data via a cell tower network to a server somewhere on the web that can query a master database and link the decoded data to a specific URL. New binary data representing the desired URL is then sent back over the cell tower network to the user's mobile handheld device. The software on the device that is unique to the given tag system automatically loads the URL into the mobile web browser.

Conceivably, as memory and processing speeds continue to increase on mobile handheld devices, the database required to link decoded binary from a matrix tag to a URL could reside on the handheld device itself. The ability to do so would thereby eliminate the need to send the decoded binary to a remote server. Regardless of whether a remote server is required to determine the URL represented by a matrix tag, the user will always be required to have specific scanner software on the handheld device.

Yet another way being used to encode URLs for easy linking of handheld devices with embedded cameras and web browsing capabilities was developed by Fujitsu. Fujitsu's technology is called FP Coding and it alters digital pictures in such a way that it is not perceptible to the human eye. Much like Data Matrix, QR Code, and ShotCode, FP Code is nothing more than a way to embed coded information in a picture. FP Code, however, is not as convenient for tagging systems and is primarily limited to use in printed materials. A common application for FP Coding would be to alter the picture of a garment being advertised in a magazine. The user of a handheld device with a digital camera and web browser could take a picture of the garment being advertised and then send the encoded picture to a remote server. The remote server then decodes the picture, queries the database for the URL linked to the garment being pictured and finally sends the binary representing the URL back to the user's handheld device. Alternatively, the decoding of the FP Code could conceivably take place on the handheld device. Regardless, an FP Code is just another way to code a URL.

The common theme among all the systems described above is that they require encoded data to be extracted from a picture before querying a database for a URL. Because a digital picture itself is nothing more than a bunch of binary data, all the systems currently being used to link a handheld device to a URL require that binary data, in essence, be extracted from a larger set of binary data.

Therefore, what is needed in the art is a new technology that can directly link the URL capability of surfing the Internet with pictures, or picture URLs. If a digital picture in and of itself can be used as a tag to represent a URL, then there will be no need for scanner and decoding software that is required by current digital tagging systems.

### BRIEF SUMMARY OF THE INVENTION

A picture URL is created by taking a picture of an object that includes a logo in the picture frame. The picture of the object and logo is uploaded to a web server for processing. The logo is processed and used to perform a normalization process on the picture. A URL is then associated with the picture. A subsequent party may take a picture of the same object and also include the logo in the picture frame, or take a picture of a picture that already includes the logo. The recent picture is then loaded up to a web search engine that first identifies the logo, processes the logo and performs a normalization process on the image. The image is then compared to a database of images to find a match. If a match is found, the associated URL is sent back to the user and loaded into a web browser. The user is then automatically directed to a web page or web content associated with the URL.

The primary embodiment of the invention includes digital pictures of any format recognizable by the system's host server. The digital picture of a tangible object contains a logo of predetermined size, color, shading, etc. so that normalization may be performed thereby increasing the success rate of matching the recent picture to the original that resides on the server and is associated with the URL. The logo does not contain any embedded code or represent any sort of digital watermarking or signature.

An alternative embodiment of the invention may associate a sound, instead of a picture, with a URL. Any device capable of recording a sound of predetermined frequency, pitch and decibal could upload the recorded sound to a web server for comparison to a database of sounds. In this way, the same functionality of a picture-URL system could be accomplished with a database of sounds, instead of pictures, associated with URLs. Once a match is made, the URL could be sent back to the user for loading in a web browser. Again, there is no need to encrypt any data within the sound file. Rather, the normalized sound is compared to a database of benchmark sounds associated with URLs.

Yet another embodiment of the invention may use video in lieu of still pictures or sounds. The host server could extract a logo from a frame in the video, normalize it, and then compare the normalized version with master pictures stored in the database and associated with URLs. Alternatively, any combination of sound and pictures from a video could be extracted for comparison to the database. Again, no encryption or decoding of embedded data required.

### BRIEF DESCRIPTION OF THE SEVERAL VIEWS OF THE DRAWING

FIG. 1 is a flow diagram illustrating an exemplary embodiment of the present invention.

FIG. 2 is a conceptual block diagram illustrating an embodiment of the present invention.

### DETAILED DESCRIPTION OF THE INVENTION

Embodiments and aspects of the present invention provide a solution to the above-described need in the art, as well as other needs in the art by providing a technique for using digital pictures, sounds, or videos as URLs. Aspects of the present invention relate to normalization techniques to improve the process of comparing uncoded digital files, so that a ‘query’ file could effectively be used to find a similar match in a database of source files.

More specifically, the normalization aspects of the present invention improves the reliability when trying to determine if a picture, for example, taken of a specific object, piece of landscape, individual person, etc., matches another picture taken of the same object, piece of landscape, individual person, etc., from a different camera, under different lighting conditions, different zoom level, color balance, rotation, etc. Similarly, the normalization aspect of the invention applied to a digital sound file may compensate for variations in pitch and decibal levels between the query file and source file.

Many software libraries already exist that attempt to match images based on color content, contrast, edge detection, and other criteria. Such technology could be used in various embodiments of the present invention as pre-processing activities before invoking those libraries to greatly improve their success rate.

One goal of the present invention is to provide a reliable way for a digital file, whether a picture, sound, or video, to be used as a URL Vector that points to a specific web address. That is, a user could record data with any digital handheld device, such as a camera embedded within a cellular telephone, and send the data to a search engine and get directed to the appropriate web content.

In the case of using a picture as the vector, the URL Vector would be created by one individual simply taking a picture with a digital camera and uploading it to a web-enabled search engine marking it as a URL (the web address provided in the upload along with the picture). This is easily done using any MMS enabled cellular telephone on most cellular networks.

Later, other users can take a picture of the same object, upload to the image-enabled search engine and get directed to the appropriate web address.

To be able to accurately match these images in a large database is not a trivial task. One aspect of the present invention is to mark these pictures being used as URL Vectors, termed as PICT-URLs, with a logo or icon that acts as an index mark to assist in the image comparison process.

This logo or icon could contain the following specific characteristics:
primary colors to assist with color balance;
white, grey, and black to assist with white balance;
known/fixed size to assist with zoom level; and
non-regular shapes to assist with orientation.

An exemplary process for the present invention includes the following steps:

First, a user creates a pict-url by placing a logo on or near the object being photographed. This logo would be in the frame of the image, for example in the lower right corner. This image would be sent to a web-enabled search engine along with a web address (URL) to define the pict-url.

Next, the system analyzes the image looking for the index mark (logo). Once the index mark is found, the mark is analyzed and then used to color/white balance, rotation orientation, zoom and scale settings, crop the image, and contrast the image. The newly normalized image is then stored (along with the original image) for later use in image comparison.

At some later point in time, another user photographs (roughly) the same image and sends it to the web searching service as a query, making sure to include the index mark (logo) in the frame of the image. Again, the system would locate the index mark and use it to normalize the image as above. Then, this normalized image is used to search the database of other normalized images for the closest match.

Finally, once a match is found, the user is sent to the appropriate URL, either by wap-push, mms, sms, or some other means appropriate to the device.

Whatever the actual image comparison routines being used, the presence of this appropriately designed index mark could dramatically improve the hit rate. It should be noted that while the use of an index mark could increase the probability of finding the appropriate match, doing so is not necessarily required for the present invention to be a viable improvement in the art. As such, it should be appreciated that an advantage of the present invention's embodiments over existing technologies is that there is no need for the query file to be identical to the source file or, alternatively, for the query file to be accurately decoded. Whether it's a picture, video, or sound byte, a URL Vector is effective so long as the query file is a match to a source file within some band of reasonable statistical error. In this way, embodiments of the present invention are unlike bar codes and two-dimensional tags that are ineffective if compromised or inaccurately scanned.

An exemplary embodiment of the present invention could use a sound, or series of sounds, as an alternative to a digital picture. In such an embodiment, the URL Vector would be a SOUND-URL. Much like the owner of a URL that chooses to link his web address to a digital picture of an object in the tangible world, the owner of a SOUND-URL may choose to link his web address to a sound, a series of notes in a given key, a jingle, or even a classical fugue for that matter. The length of the recording is only relevant as to the ease of which it could be matched. A short recording, say a single note for example, would be prone to multiple URL matches as it could be confused with numerous other single notes existing in the database as a normalized sound. More lengthy and complicated recordings would virtually guarantee a single match to a normalized recording in a database. In reality, any sound capable of being recorded more than once could be employed as a SOUND-URL.

The process by which an owner of a URL could use a sound to represent his web address closely mirrors the PICT-URL process. Namely, the owner of the URL records the sound and uploads it to a web server along with his URL. The recording is normalized to take into account decibal level, background noise, pitch, etc. and then stored in a database along with the URL. Later, a recording by another of the same sound could be uploaded, normalized, and then compared for a match in the database. Once the match is found, the appropriate URL is sent back to the user for loading into a web browser.

Yet another embodiment of the present invention could use a video in lieu of a still picture or sound. The owner of a web address could record a video or clip of just about anything and upload it to a web server along with a web address. Just the same as a PICT-URL or SOUND-URL, a VID-URL may require that the source video be normalized to take in consideration variations in lighting, distance, color balance, etc. Once normalized, the video could be compared to a video taken by a mobile handheld user. If a match is found, then the appropriate web address is sent back to the user.

The present invention can be used in variety of applications. As an example, two applications are described.

One non-limiting example of an application for the PICT-URL embodiment of the present invention includes placing logos on advertising. By doing so, any poster, billboard, signage, etc. would in essence become a URL Vector. Consumers desiring to access information about the advertisement could just take a picture of an ad and get directed to the URL. For instance, in a web enabled cellular telephone that includes a digital camera, the user could take the picture and upload the picture through a browser and automatically be directed to the web site. Advantageously the user does not have to write down a URL or remember the address. Rather, the user can instantly access the web site or store the image in his or her camera for later access. Further, because the picture itself contains no embedded code, there is no requirement for the user's handheld device to run any special decoding software. The picture, in essence, stands for itself as a URL Vector.

Another application of the present invention allows individuals to create their own URL Vectors wherever they want by, for example, placing a logo on an object, taking a picture of it and registering it as a URL. Users may be required to pay for the creation of the URL, but it would be free for others to click on it and access the URL. This is similar to how current URL registration is performed. The company providing this service, such as SNAPHERE, would host the registration and also provide web space/homepages for people to use as the directed URL (for blogs, etc). It should be appreciated that many different pictures might point to the same URL.

It should also be appreciated that the URL provided does not have to result in a simple redirection to content. Rather, it is also possible that the URL might take some action: such as register a user, purchase an item, or perform other similar actions available from any other web page/form.

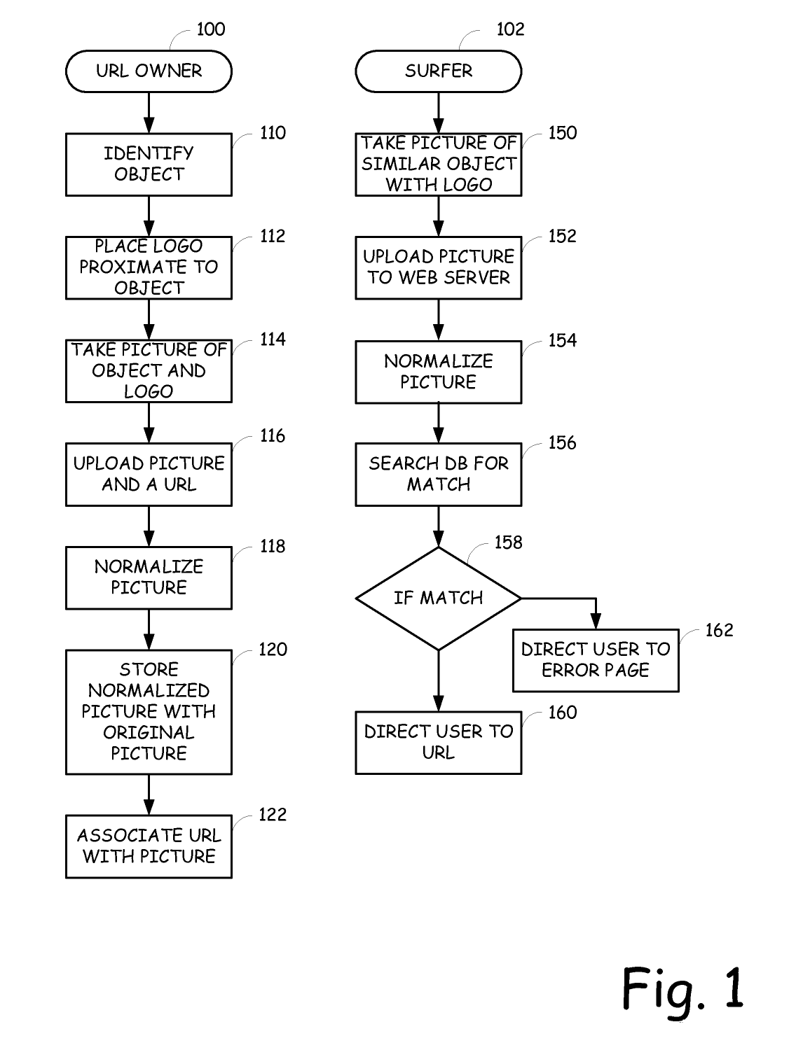

Now turning to the figures in which like numerals and labels represent like elements throughout the several views. FIG. 1 is a flow diagram representing an exemplary embodiment of the URL Vector invention.

In the illustrated non-limiting example of the invention, the owner of a web address, or URL Owner 100, employs the use of a digital picture as a URL Vector. To create the PICT-URL type of URL Vector, the URL Owner 100 identifies an object 110 in the tangible world. He then places a standardized logo, or some other index mark, proximate to the selected object 112. Once the logo has been placed proximate to the selected object 112, the URL Owner 100 takes a digital picture of the object and logo 114. Next, the URL Owner 100 uploads the picture, along with his web address, to a web server 116. The web server conducts a normalization process 118 on the picture to adjust for contrast, balance, zoom, and orientation based on the standardized logo located within the picture. The normalized version of the picture is stored in a database 120 located on the server and associated with the previously uploaded web address 122.

A person with access to the internet, or surfer 102, wishing to acquire information located at the URL Owner's 100 web address can take a picture of the object, or a similar or identical object, being sure to include the proximate logo 150. The surfer's 102 image can now be used as a query image to automatically link him to the URL Owner's 100 online content. To do so, the surfer 102 uploads his recent image of the object and logo 150 to the web server 152. The web server performs the normalization process 154 to adjust for contrast, balance, zoom, and orientation. Once normalized 154, the web server can search its database 156 for a source picture 118 that most closely matches the surfer's 102 recent normalized picture 154. If a match, or a close match (i.e., one that falls within a defined threshold of proximity), is found then the surfer 102 is directed to the appropriately linked web address 160. If no match is found, then the surfer 102 is simply directed to an error page 162.

In another exemplary embodiment of the present invention, a URL Owner 100 could use a digital sound, or series of sounds, as a URL Vector. To create the SOUND-URL type of URL Vector, the URL Owner 100 identifies a sound instead of a tangible object 110 to represent his web address. Much like the use of a picture as a PICT-URL, a sound that is to be used as a SOUND-URL may include a standardized sound, or series of sounds, for use as a benchmark in the normalization process. The URL Owner 100, therefore, would record a sound that included the standardized index sound 114 and then upload it to a web server along with his web address 116. The web server, in turn, would normalize the sound and adjust for variations in pitch and decibal strength 118. Finally, the web server would store the normalized sound 120 and associate it with the previously uploaded web address 122.

From this point, an internet surfer 102 interested in accessing web content associated with a SOUND-URL could record the sound being sure to include the standardized sounds in the recording 150. Next, the surfer 102 could upload the sound recording to a web server 152 which would, in turn, perform the normalization process 154. Once normalized, the web server would compare the recently uploaded recording from the surfer 102 to a database of source sound recordings 156. If a match is found, then the surfer 102 would be redirected to the associated web address 160. If no match is found, the surfer 102 would be directed to an error page 162.

In yet another exemplary embodiment of the present invention, a URL Owner 100 can use a digital video recording as a URL Vector. To create the VID-URL type of URL Vector, the URL Owner 100 identifies a video instead of a tangible object 110 to represent his web address. Much like the use of a picture as a PICT-URL, a video recording that is to be used as a VID-URL may include a standardized object, or series of objects and/or sounds, for use as a benchmark in the normalization process. The URL Owner 100, therefore, would record a video that included the standardized index objects or sounds 114 and then upload it to a web server along with his web address 116. The web server, in turn, would normalize the video 118. Finally, the web server would store the normalized video 120 and associate it with the previously uploaded web address 122.

At this point, an internet surfer 102 interested in accessing web content associated with a VID-URL could record the video being sure to include the standardized objects or sounds in the recording 150. Next, the surfer 102 could upload the recording to a web server 152 which would, in turn, perform the normalization process 154. Once normalized, the web server could compare the recently uploaded recording from the surfer 102 to a database of source video recordings 156. If a match is found, then the surfer 102 would be redirected to the associated web address 160. If no match is found, the surfer 102 would be directed to an error page 162.

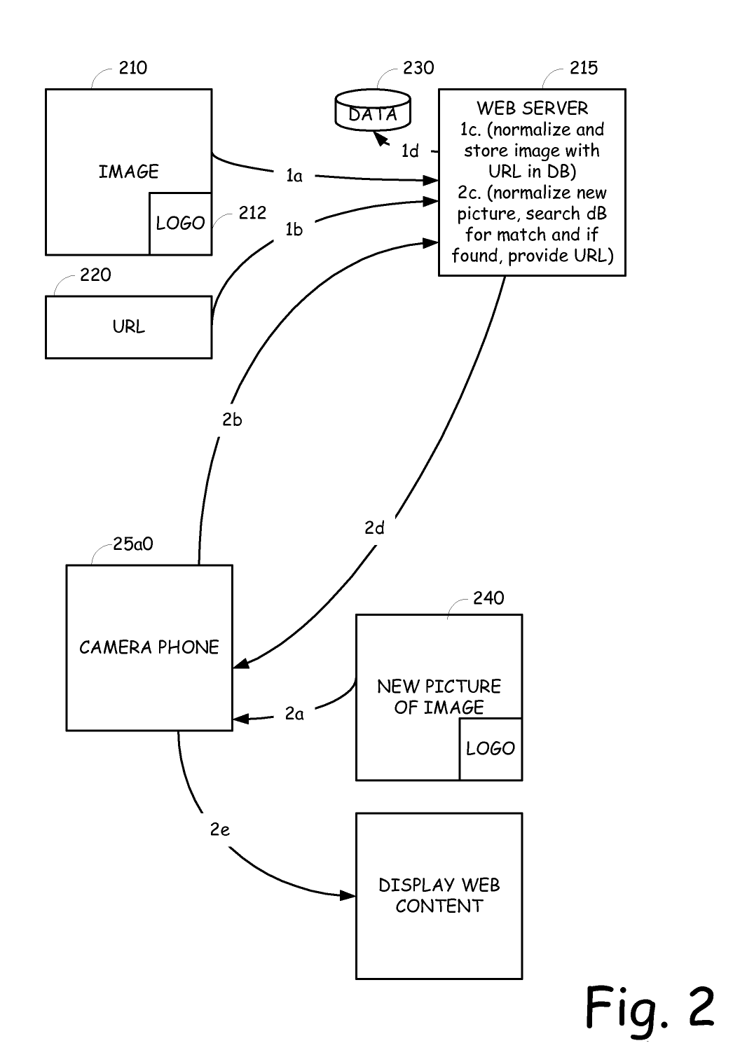

FIG. 2 is a conceptual block diagram illustrating an embodiment of the present invention. This embodiment of the invention is presented as a non-limiting example and those skilled in the art will appreciate that the illustrated aspects of the invention can be applied in many more settings than what is illustrated, although the illustrated embodiment may in and of itself be considered patentable.

An image 210 that includes a logo 212 is provided to a web server 215 at transition 1a along with a URL 220 at transition 1b. The web server 215 then operates to normalize and store the image with the URL 1c into a database 230 at transition 1d.

A new image 240 that includes as a portion of the image the logo 212 is obtained 2a by using a device such as a digital camera or camera phone 250. This digital representation is provided to the web server 215 2b. The web server 215 then normalizes this digital representation 2c and then searches the database 230 to determine if there is a match. Advantageously, this aspect of the present invention allows for the application of fuzzy logic or approximations and, as such, and exact match is not required. If a suitable match is found, the URL associated with the match is obtained from the database and provided to the requesting device 2d. The requesting device then uses the URL to access and display web content 2e.

Thus, various aspects, features and embodiments of the present invention have been provided. It should be appreciated that although certain combinations of such aspects, features and embodiments may be patentable, the present invention is not so limited.

What is claimed is:

1. A method for employing an index or logo mark to improve image recognition for normalized comparison, the method comprising the steps of:
positioning a logo mark in close proximity to an object;
taking a first digital image of the object, the digital image encompassing the logo mark;
normalizing the first digital image based at least in part on the known characteristics of the logo mark;
storing the first normalized digital image into a database;
receiving a second digital image of an object, the second digital image encompassing the logo mark;
normalizing the second digital image based at least in part on the known characteristics of the logo mark; and
comparing the normalized second digital image to the normalized first digital image to determine if they match.

2. The method of claim 1, wherein the step of normalizing the first and second digital images further comprises adjusting the color balance of the digital images.

3. The method of claim 1, wherein the step of normalizing the first and second digital images further comprises adjusting the white balance of the digital images.

4. The method of claim 1, wherein the step of normalizing the first and second digital images further comprises adjusting the orientation of the digital images.

5. The method of claim 1, wherein the step of normalizing the first and second digital images further comprises adjusting the zoom of the digital images.

6. The method of claim 1, wherein the step of normalizing the first and second digital images further comprises cropping of the digital images.

7. A method for employing an uncoded digital file as a uniform resource locator vector (URL vector), the method comprising the steps of:
obtaining a representation of a URL vector;
sending the representation to an analyzer; and
receiving back from the analyzer an internet based address associated with the URL vector.

8. The method of claim 7, wherein the uncoded digital file being employed as a URL vector is of a digital picture format, the method further comprising the steps of:
taking a digital picture of an object;
normalizing the picture;
storing the normalized picture in a database along with a web address;
obtaining a second digital picture;
normalizing the second picture;
querying a database for a stored picture that is a close match with second picture; and
upon finding a close match, providing the web address linked in database to stored picture.

9. The method of claim 7, wherein the step of normalizing the picture further comprises the step of using a logo located within the picture to aid in subsequent picture comparisons.

10. The method of claim 7, wherein the step of normalizing the picture further comprises the use of a web server for application of the normalization process.

11. The method of claim 7, wherein the step of normalizing the picture further comprises the use of a digital camera phone, PDA, or other handheld device for application of the normalization process.

12. The method of claim 7, wherein the step of querying the database comprises the use of a web server for database storage and said query.

13. The method of claim 7, wherein the step of querying the database comprises the use of a handheld device for database storage and said query.

14. The method of claim 1, wherein the uncoded digital file being employed as a URL vector is of a digital video format, the method being comprised of the following steps:
recording of a video in a digital format;
normalizing the video;
storing the normalized video file in a database along with a web address;
obtaining a second digital recording;
normalizing the second video recording;
querying a database for a stored video recording that is a close match with second video recording; and
upon finding a close match, providing the web address linked in database to original recording.

15. The method of claim 14, wherein the step of normalizing the video recording further comprises the step of including a standard object, or series of objects, located within the video to aid in subsequent video comparisons.

16. The method of claim 14, wherein the steps of normalizing the video recordings further comprises the use of a web server for application of the normalization process.

17. The method of claim 14, wherein the steps of normalizing the video recordings further comprises the use of a digital phone, PDA, or other handheld device for application of the normalization process.

18. A method for providing access to web content through the use of an uncoded object, the method comprising the steps of:
obtaining a plurality of digital representations, each digital representation being associated with at least a portion one of a plurality of uncoded object;
associating each of the plurality of digital representations with a network based address;
receiving a request from a browsing device for a network based address, the request comprising a digital representation of a selected object;
comparing the digital representation of the selected object to the plurality of digital representations to identify a match that meets particular threshold requirements;
upon finding such a match, identifying the network based address associated with the matching digital representation; and
providing the network based address to the browsing device.

19. The method of claim 18, wherein the digital representations are digital photos of objects, and the method further comprising the step of normalizing the obtained digital representations prior to said associating step.

20. The method of claim 19, wherein the object has a logo that is affixed upon the object or in close proximity to the object and the digital representation includes at least the logo, and the step of normalizing the digital representation further comprises the step of using the logo located within the digital representation to aid in subsequent picture comparisons.
